(19) United States
(12) Patent Application Publication
(10) Pub. No.: US 2010/0259647 A1
(43) Pub. Date: Oct. 14, 2010

(54) PHOTOGRAPHIC EFFECT FOR DIGITAL PHOTOGRAPHS

(76) Inventor: Robert Gregory Gann, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/421,468

(22) Filed: Apr. 9, 2009

(51) Int. Cl. H04N 5/262; G06K 9/46

(52) U.S. Cl. 348/239; 382/195; 348/E05.051

(57) ABSTRACT

Systems and methods are disclosed for applying a photographic effect to a displayed image. An exemplary method may include detecting the presence of at least one face in the displayed image. The method may also include determining the region within which the at least one face is located in the displayed image. The method may also include applying a photographic effect based on the region within which the at least one face is located.

### BACKGROUND

Conventional film and more recently, digital cameras, are widely commercially available, ranging both in price and in operation from sophisticated single lens reflex (SLR) cameras used by professional or semi-professional photographers, to inexpensive “point-and-shoot” cameras that nearly anyone can use with relative ease.

Digital cameras are available with user interfaces that enable a user to select various camera features for adding effects to their photographs on the camera. However, many of these effects are applied automatically to the entire photograph, without regard to the subject of the photograph. For example, a border effect applied to the perimeter of a photograph may overlap a portion of a person that is the subject of the photograph, essentially “cutting off” some or even all of the person's head in the photograph.

Photo-editing software is available that enables a user to apply effects to their photographs with more control. However, this more sophisticated photo-editing software is typically not available on cameras due to processing and operational considerations in the camera environment, and therefore requires that the user first transfer their photographs to their personal computer (PC) before being able to apply effects to their photographs.

### BRIEF DESCRIPTION OF THE DRAWINGS

FIG. 1 is a block diagram of an exemplary camera system which may be used for applying a photographic effect to a displayed image.

FIG. 2 is an image which may be displayed on a camera system illustrating exemplary face detection techniques which may be implemented before applying a photograph effect to the displayed image.

FIG. 3 are images illustrating application of a photographic effect to the displayed image.

FIG. 4 are images illustrating another application of a photographic effect to the displayed image.

FIG. 5 are images illustrating another application of a photographic effect to the displayed image.

FIG. 6 are images illustrating another application of a photographic effect to the displayed image.

FIG. 7 is a flowchart illustrating exemplary operations to apply a photographic effect to an image displayed by the camera.

### DETAILED DESCRIPTION

Systems and methods are disclosed for applying one or more photographic effects to displayed images on a digital camera without distorting or otherwise adversely affecting the appearance of the subject's face (or subjects' faces) in the displayed image. Exemplary systems may be implemented as an easy-to-use interface displayed on the digital camera and navigated by the user with conventional camera controls (e.g., arrow buttons and zoom levers already provided on the camera). The user needs little, if any, knowledge about photo-editing, and does not need special software on their PC to apply these effects to their photographs. Various user options may also be made available on the camera itself so that the desired effect can be readily selected by the user from a plurality of settings.

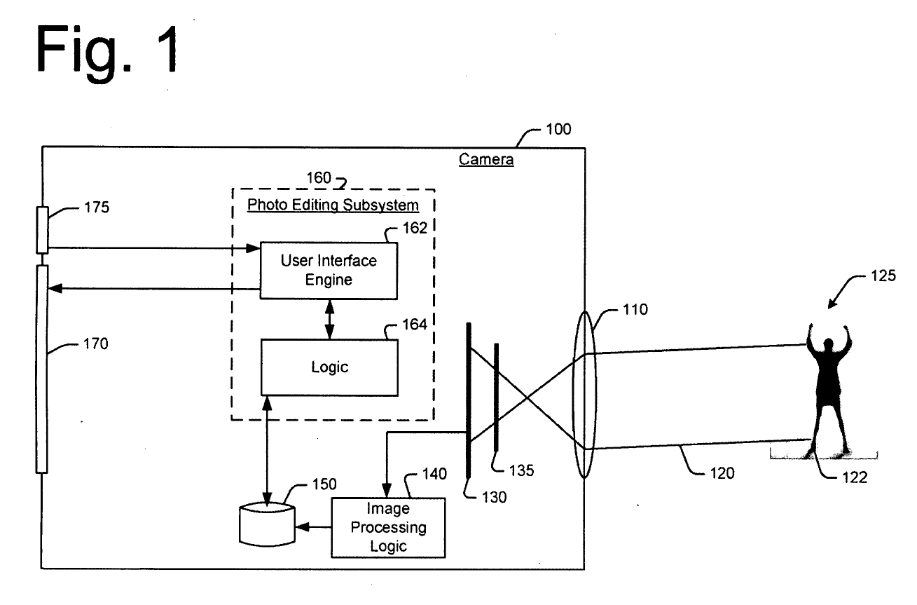

FIG. 1 is a block diagram of an exemplary camera system which may be used for applying a photographic effect to a displayed image. The exemplary camera system 100 may be a digital camera including a lens 110 positioned to focus light 120 reflected from one or more objects 122 in a scene 125 onto an image capture device or image sensor 130 when a shutter 135 is open (e.g., for image exposure). Exemplary lens 110 may be any suitable lens which focuses light 120 reflected from the scene 125 onto image sensor 130.

Exemplary image sensor 130 may be implemented as a plurality of photosensitive cells, each of which builds-up or accumulates an electrical charge in response to exposure to light. The accumulated electrical charge for any given pixel is proportional to the intensity and duration of the light exposure. Exemplary image sensor 130 may include, but is not limited to, a charge-coupled device (CCD), or a complementary metal oxide semiconductor (CMOS) sensor.

Camera system 100 may also include image processing logic 140. In digital cameras, the image processing logic 140 receives electrical signals from the image sensor 130 representative of the light 120 captured by the image sensor 130 during exposure to generate a digital image of the scene 125. The digital image may be stored in the camera's memory 150 (e.g., a removable memory card).

Shutters, image sensors, memory, and image processing logic, such as those illustrated in FIG. 1, are well-understood in the camera and photography arts. These components may be readily provided for digital camera 100 by those having ordinary skill in the art after becoming familiar with the teachings herein, and therefore further description is not necessary.

Digital camera 100 may also include a photo-editing subsystem 160. In an exemplary embodiment, photo-editing subsystem 160 is implemented in program code (e.g., firmware and/or software) residing in memory on the digital camera 100 and executable by a processor in the digital camera 100, such as the memory and processor typically provided with commercially available digital cameras. The photo-editing subsystem 160 may include a user interface engine 162 and logic 164.

Logic 164 may be operatively associated with the memory 150 for accessing digital images (e.g., reading the images stored in memory 150 by image processing logic 140 or writing the images generated by logic 164). Logic 164 may include program code for analyzing the digital images (or a selected digital image) and applying a photographic effect to the digital images stored on the camera system 100, as explained in more detail below. The logic 164 may also be operatively associated with the user interface engine 162.

User interface engine 162 may be operatively associated with a display 170 (e.g., a liquid crystal display (LCD)) and one or more camera controls 175 (e.g., arrow buttons and zoom levers) already provided on many commercially available digital cameras. Such an embodiment reduces manufacturing costs (e.g., by not having to provide additional hardware for implementing the photo-editing subsystem 160), and enhances usability by not overwhelming the user with additional camera buttons.

During operation, the user interface engine 162 displays an effects menu on the digital camera (e.g., on display 170). In an exemplary embodiment, the effects menu may be accessed by a user selecting the “Design Gallery” menu option. The effects menu may then be navigated by a user making selections from any of a variety of menus options. For example, the user interface engine 162 may receive input (e.g., via one or more of the camera controls 175) identifying user selection(s) from the effects menu. The logic 164 may then be implemented to apply a photographic effect to a digital image stored in the digital camera 100 (e.g., in memory 150) based on user selection(s) from the effects menu.

A preview image may be displayed on display 170 so that the user can see the photographic effect as it may be applied to the photograph. Optionally, instructive text may also be output on display 170 for modifying, or accepting/rejecting the photographic effect. The instructive text may be displayed until the user operates a camera control 175 (e.g., presses a button on the digital camera 100). After the user operates a camera control 175, the text may be removed so that the user can better see the preview image and photographic effect on display 170.

Also optionally, the user may operate camera controls 175 (e.g., as indicated by the instructive text) to modify the photographic effect. For example, the user may press the left/right arrow buttons on the digital camera 100 to select the type of photographic effect, and/or one or more option for the selected photographic effect (e.g., increase or decreasing the degree of slimming to be applied to the photograph when applying the slimming effect).

In an exemplary embodiment, a copy of the original digital photograph is used for applying the photographic effect. For example, the new image may be viewed by the user on display 170 directly after the original image so that the user can readily see both the original image and the modified image.

Before continuing, it is noted that the digital camera shown and described above with reference to FIG. 1 is merely exemplary of a camera system which may implement a photographic effect for digital photographs. The systems and methods described herein, however, are not intended to be limited only to use with the camera system 100. Other embodiments of camera systems which may implement a photographic effect for digital photographs are also contemplated.

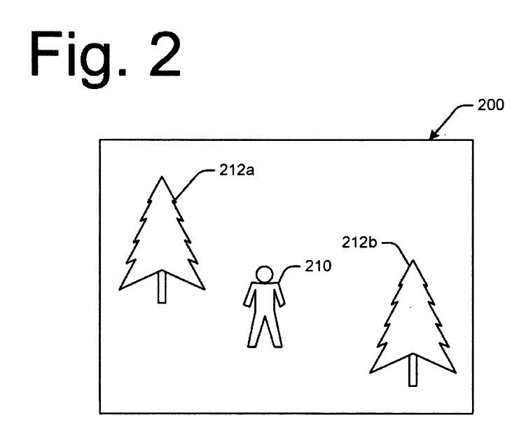

FIG. 2 is an image 200 which may be displayed on a camera system illustrating exemplary face detection techniques which may be implemented before applying a photograph effect to the displayed image. In an exemplary embodiment, the image may be generated and displayed by the camera system 100 in FIG. 1, e.g., on display 170.

Image 200 is shown with the subject 210 appearing as originally captured by the camera. Background objects (e.g., trees 212a and 212b) are also shown in the image 200. Of course image 200 is a simplified illustration of an image which may be captured by a camera system. Actual images 200 may vary in content and may include one or more subject and a wide variety of different background objects.

In use, the camera user may desire to apply one or more photographic effect to the image 200. For example, the user may desire to apply a slimming effect so that the subject 210 of the image appears to be thinner in the photograph. Or for example, the user may desire to apply a vignetting or border effect. A wide variety of photographic effects are known in the camera and digital image arts. Other examples include, but are not limited to artistic effects (such as center focus, soft glow, kaleidoscope, solarize), and other photo enhancement effects (such as touch-up, and photo retouching).

Another exemplary photographic effect which the teachings herein may be applied is panorama stitching. Panorama stitching is an effect wherein multiple adjacent images are combined into a single image to give a panoramic view of the scene being photographed. Panorama stitching benefit from the teachings herein by recognizing that a face is in an overlap area between two photos and the face portion of the image is then preserved.

In an exemplary embodiment, the camera user may not only select one or more photographic effect, but the camera user may also select from various options for applying the photographic effect to the displayed image. For example, where the photographic effect is the slimming effect, the options may be preprogrammed to correspond to various amounts of compression of the digital image. Although the user may be prompted directly for the amount of compression, in order to make the interface more user-friendly, more general terminology may be displayed for the user. For example, the user may select between “thin,” “thinner,” and “thinnest.” Similarly, other options may be made available to the user for other photographic effects (e.g., border style and color for the border effect).

It is noted that providing user-friendly options simplifies the user interface and also reduces processing requirements and time to produce the photographic effect. Accordingly, the photographic effect can be readily implemented on an embedded system, such as the camera system 100 described above with reference to FIG. 1.

Of course other selections may also be implemented and are not limited to the user-friendly selections given above as examples. In other embodiments, a slider (e.g., the camera's zoom lever) or other user input may allow the user to tailor the photographic effect.

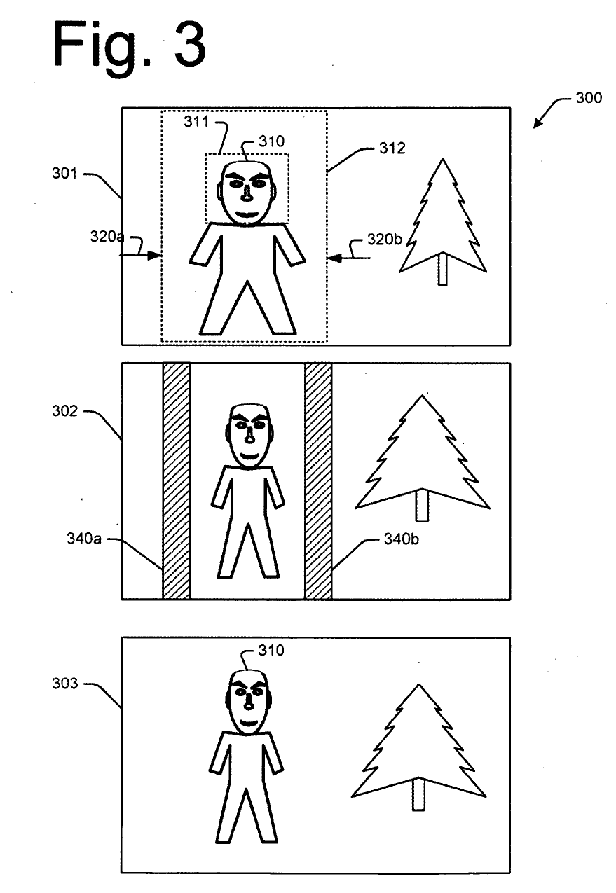

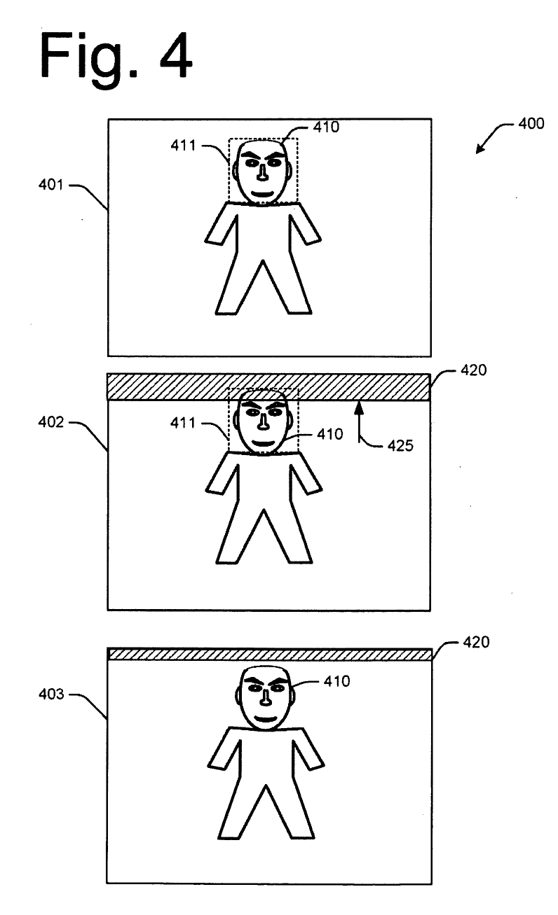

Application of a photographic effect without distorting or otherwise adversely affecting appearance of a subject in the displayed image can be better understood with reference to the illustrative examples shown in FIGS. 3 and 4.

FIG. 3 are images 300 illustrating application of a photographic effect to the displayed image. In FIG. 3, image 301 represents the original image captured by the camera system, and images 302 and 303 illustrate application of a photographic effect to the original image 301. The person in images 301-303 represents the subject (e.g., person 210 in FIG. 2). It is noted that no background objects (e.g., trees 212a and 212b shown in FIG. 2) are shown in FIG. 3 to simplify the drawings.

As a preprocessing step prior to applying a photographic effect, the camera logic (e.g., logic 164 in FIG. 1) may determine the presence of one or more face 310 in the image 301. Face detection algorithms are well known in the photographic arts. In general, these face detection algorithms operate by identifying pixels within an image corresponding to one or more features of a face. If the image includes other objects within the image data or is an image including the face and body of a person, the face detection algorithm locates the pixels within the image corresponding only to the face.

To facilitate locating the face 310 in the image 301, the face detection algorithm may search only predetermined areas of the image 301. These predetermined areas may be defined in the center of the image 301, next to other faces in the image 301, or based on other common areas where faces commonly appear in images.

If the face detection algorithm locates a plurality of faces in the image 301 (e.g., a photograph of a crowd of people), it may be desirable to only use the more prominent face(s) in the image 301 as these are most likely to correspond to the subject(s) of the photograph. Depending on the desired emphasis, different weighting factors may be applied to detect the presence of a subject's face in the image 301.

Following this preprocessing operation wherein the presence of a face is detected in the image 301, the photographic effect may be applied to one or more portion of the image 301 include a portion 311 of the image including the face 310. In the example shown in FIG. 3, the user may select a “slimming effect” as the photographic effect to be applied the image 301.

The slimming effect may be applied using a compression algorithm that executes on the camera (e.g., by logic 164 in camera system 100 shown in FIG. 1). The compression algorithm compresses the image 301 in one dimension, as illustrated by arrows 320a-b in FIG. 3. The amount of compression may correspond to the user's selection. For example, if the user selects “thinner,” the pixels in image 301, or in a portion 312 of the image 301 (excluding the portion 311 with the face 310), may be compressed from 620 pixels wide to 580 pixels wide.

It is readily observed that the body 330 in the compressed portion 312 appears thinner in image 302. However, compressing the pixels in portion 312 of the image 301 also changes the aspect ratio of the original image 301. In order to maintain the aspect ratio of the original digital photograph 301, the compressed image 302 may be “stretched” in the opposite direction. In an exemplary embodiment, portions 340a and 340b on both sides of the compressed subject 312 are stretched.

It is noted that if the slimming effect were applied to the center of the image, that a person standing to one side of the center would actually be “stretched” and appear to be “fatter.” This can be seen by what has happened to the tree during stretching between images 301 and 302. But by first detecting the position of the subject in the photograph, the slimming effect can be selectively applied to the area of the photograph including the subject, hence making the subject appear “thinner.”

Techniques for stretching (or up-sampling) images are well-understood in the digital image arts. In an exemplary embodiment, stretching the digital image 302 may be accomplished by populating pixels in the stretched area with actual and/or estimated pixel values. For example, every other pixel (every third pixel, etc.) in the stretched area may be populated with the actual pixel values in the areas between the edges of the compressed image 302. The “missing” pixels may then be populated with pixel values from the pixels that are adjacent (or near-adjacent) the missing pixels. Optionally, techniques for averaging and/or blending may also be implemented for populating the pixel values in the stretched area. Alternatively, pixel values for the sides of the image may be stored in memory and retrieved when stretching the compressed image 302. Still other embodiments are also contemplated.

It can be readily observed in image 303, which has been compressed and stretched, that the subject's body 330 appears thinner than in the original image 301.

FIG. 4 are images 400 illustrating application of another photographic effect to the displayed image. In FIG. 4, image 401 represents the original image captured by the camera system, and images 402 and 403 illustrate application of a photographic effect to the original image 401. Again, the person in images 401-403 represents the subject (e.g., person 210 in FIG. 2) and no background objects (e.g., trees 212a and 212b shown in FIG. 2) are shown in FIG. 4 to simplify the drawings.

Again in the example shown in FIG. 4, a preprocessing operation may be executed before applying the photographic effect. Accordingly, the camera logic (e.g., logic 164 in FIG. 1) may determine the presence of one or more face 410 in the image 401. Following this preprocessing operation, the photographic effect may be applied to one or more portion of the image 401 excluding a portion 411 of the image including the face 410. In the example shown in FIG. 4, the user may select a “border effect” as the photographic effect to be applied the image 401.

The border effect may be applied using a drawing algorithm that executes on the camera (e.g., by logic 164 in camera system 100 shown in FIG. 1). The drawing algorithm overlays pixels in the image 401 along one or more perimeter of the image 401. The size, color, and/or other attributes of the border 420 may correspond to the user's selection.

It is readily observed that the border selected by the user overlays a portion of the subject's face 410 in image 402. However, the border 420 may be reduced in size, e.g., as indicated by arrow 425 so that the edge of the border 420 does not overlay the subject's face 410. The border 420 may also be sized to maintain a suitable buffer (defined by a predetermined number of pixels, percentage of the photo, or some area driven by the size of the face) between the border 420 and the subject's face 410.

It can be readily observed in image 403, which has the border 420 applied, that the subject's face 410 is not obscured by the border. Of course other methods for applying a border are also contemplated. For example, a border may be applied using a filter that progressively increases blur as a function of the distance from the at least one face in the image.

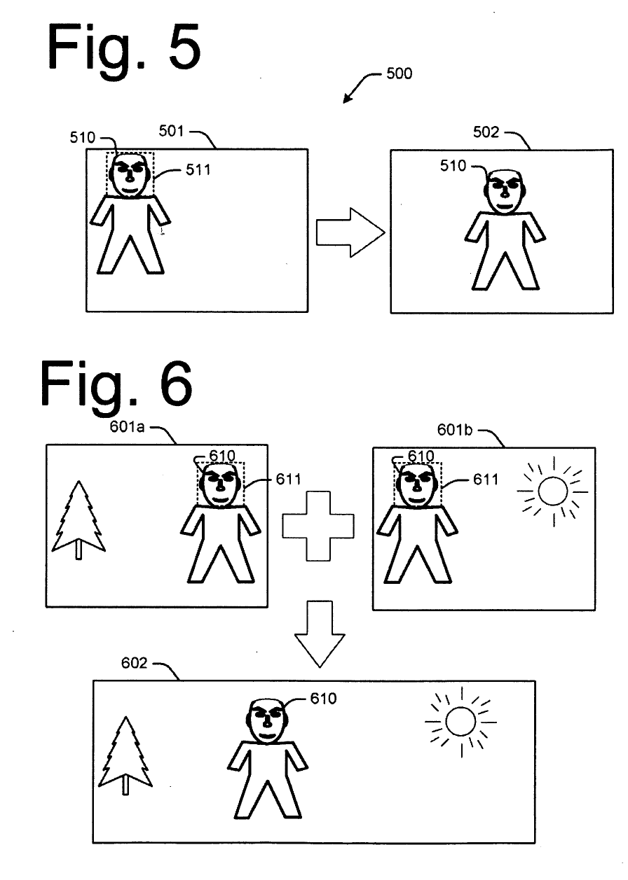

FIG. 5 are images 500 illustrating another application of a photographic effect to the displayed image. In FIG. 5, image 501 represents the original image captured by the camera system, and image 502 illustrates application of a photographic effect to the original image 501. Again, the person in images 501-502 represents the subject (e.g., person 210 in FIG. 2) and no background objects (e.g., trees 212a and 212b shown in FIG. 2) are shown in FIG. 4 to simplify the drawings.

Again in the example shown in FIG. 5, a preprocessing operation may be executed before applying the photographic effect. Accordingly, the camera logic (e.g., logic 164 in FIG. 1) may determine the presence of one or more face 510 in the image 501. Following this preprocessing operation, the photographic effect may be applied to one or more portion of the image 501. But in this example, the photographic effect includes centering the image about the face 510 so that the subject's face is at or near substantially the center of the image, as shown by displayed image 502.

The centering effect may be applied using a moving algorithm that executes on the camera (e.g., by logic 164 in camera system 100 shown in FIG. 1). The moving algorithm cuts out pixels in this example from the lower and right-hand portions of the image 501 and adds pixels back into the upper and left-hand portions of the image 501 to generate the displayed image 502. Adding in pixels may be accomplished, e.g., similarly to the stretching operations described above for the slimming effect.

FIG. 6 are images illustrating another application of a photographic effect to the displayed image. In FIG. 6, images 601a and 601b represent the original images captured by the camera system, and image 602 illustrates application of a photographic effect by combining the original images 601a and 601b to achieve a panoramic effect. Again, the person in images represents the subject (e.g., person 210 in FIG. 2). In this example, however, background objects (e.g., a tree and the sun) are shown to illustrate the panoramic effect.

Again in the example shown in FIG. 6, a preprocessing operation may be executed before applying the photographic effect. Accordingly, the camera logic (e.g., logic 164 in FIG. 1) may determine the presence of one or more face 610 in the images 601a and 601 b. Following this preprocessing operation, the photographic effect may be applied by “stitching” the images 601a and 601b together at a portion excluding the face 610, as shown by displayed image 602. In this example, the face detection operations are useful in ensuring a subject's face is not distorted when stitching multiple images together using the panoramic effect.

Before continuing, it is noted that any of a wide variety of different algorithms may be implemented for the face detection operations. It is also noted that any of a wide variety of different photographic effects may be applied. The examples of the “slimming effect” shown in FIG. 3 and the “border effect” shown in FIG. 4 are merely illustrative and not intended to be limiting in any way. In exemplary embodiments where the operations are being implemented on a digital camera, selection of algorithms and photographic effects may depend at least to some extent on the processing and memory constraints of the camera system. These and other algorithms and photographic effects now known or later developed may be implemented, as will be readily apparent to one having ordinary skill in the art after becoming familiar with the teachings herein.

### Exemplary Operations

Exemplary operations may be embodied as logic instructions on one or more computer-readable medium. When executed on a processor (e.g., in the camera), the logic instructions implement the described operations. In an exemplary embodiment, the components and connections depicted in the figures may be implemented.

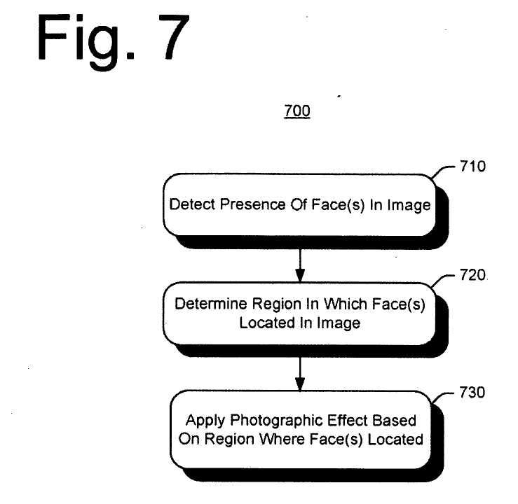

FIG. 7 is a flowchart illustrating exemplary operations 700 to apply a photographic effect to an image displayed by the camera. In operation 710, a digital photograph may be analyzed to detect the presence of one or more face in the image. In one embodiment, the entire digital photograph may be analyzed. In other embodiments, predetermined areas of the digital photograph may be analyzed for face detection.

In operation 720, a region is determined in which the one or more face is located in the image. It is also noted that more than one region including one or more faces may be identified in the image. In one embodiment, the region(s) may be defined with a boundary substantially corresponding to the edges of the subject's face. Of course, the region may be defined to have any suitable boundary. In another exemplary embodiment, the region may include a buffer zone. For example, a buffer zone may be used where it is desired that the photographic effect (such as a border) not be applied directly adjacent the edge of the subject's face.

In operation 730, the photographic effect is applied based on the region where the one or more face is located. In an example where the photographic effect is the “slimming effect” described above, the region(s) of the image excluding the face is compressed and then stretched (e.g., by up-sampling or other suitable method) an amount corresponding to the necessary replacement of the lost dimensions in the compressed image. As such, the stretched image is rendered with a subject that appears thinner than in the original digital image, while retaining substantially the same aspect ratio as the original digital photograph and without distorting the subject's face. In another example where the photographic effect is the “border effect” described above, the border may be sized so that the border does not to overlap the subject's face. Still other photographic effects may be applied in a similar manner so as not to distort or otherwise adversely affect the appearance of the subject's face in the photograph. In other embodiments, the effect may be applied to the face itself, rather than outside the region of the face. For example, the method may be used to identify the face(s) and apply softening (e.g., romantic) filters to the faces themselves.

It is noted that the exemplary embodiments shown and described are provided for purposes of illustration and are not intended to be limiting. Still other embodiments for implementing a photographic effect for digital photographs are also contemplated.

1. A method for applying a photographic effect to a displayed image, comprising:
detecting the presence of at least one face in the displayed image,
determining the region within which the at least one face is located in the displayed image; and
applying at least one photographic effect based on determining the region within which the at least one face is located.

2. The method of claim 1, wherein the applying step includes applying a slimming filter or a vignetting filter based on the region which the at least one face is located.

3. The method of claim 1, wherein the applying step includes applying a photographic effect to the at least one face.

4. The method of claim 1, wherein the applying step includes centering the region within which the at least one face is located.

5. The method of claim 4, further comprising constructing a border outside of the region within which the at least one face is located.

6. A method for applying a photographic effect to a displayed image, comprising:
detecting the presence of at least one face in an image file;
determining the region in the image file within which the at least one face is located;
modifying the image file to optimize a photographic effect based on determining the region in the image file within which the at least one face is located; and
displaying an image corresponding to the image file.

7. The method of claim 6, wherein the modifying step includes applying a filter that progressively increases blur as a function of the distance from the at least one face in the image.

8. The method of claim 6, wherein the modifying step includes positioning the at least one face near the center of the displayed image.

9. The method of claim 6, wherein the modifying step includes applying a slimming filter to an area including the at least one face.

10. The method of claim 6, wherein the applying step includes applying a vignetting filter outside of the region within which the at least one face is located.

11. The method of claim 6, further comprising:
detecting the presence of a second face in the image file;
in determining the region in the image file within which the second face is located:
modifying the image file to optimize the photographic effect based on determining the region in the image file within which the second face is located; and
displaying an image corresponding to the image file.

12. The method of claim 11, wherein the modifying step includes applying a slimming filter to the region in the image file within which the second face is located.

13. The method of claim 11, wherein the modifying step includes positioning the second face near the center of the displayed image.

14. A processing module that applies a photographic effect to an image file, the module comprising:
logic for analyzing an image to detect the presence at least one face in the image file;
logic for identifying an area in which the at least one face is located in the image file; and
logic for applying a photographic effect to a region based on the area in which the at least one face is located.

15. The processing module of claim 14, wherein the photographic effect is panorama stitching.
